(19) United States
(12) Patent Application Publication
(10) Pub. No.: US 2008/0075812 A1
(43) Pub. Date: Mar. 27, 2008

(54) Method and apparatus for burger bundling

(76) Inventor: Scott W. Jacobs, St. Marys, PA (US)

Correspondence Address: Louis A. Margiotti, Esq, 221 N. Mill Avenue, Ridgway, PA, 15853, US

(21) Appl. No.: 11/903,254

(22) Filed: Sep. 21, 2007

Related U.S. Application Data
(60) Provisional application No. 60/846,276, filed on Sep. 22, 2006.

(51) Int. Cl. A21D 13/00; A21D 8/02

(52) U.S. Cl. 426/94; 426/275

(57) ABSTRACT

A method and apparatus for making a food product where in a precooked meat or vegetable item is sealed in a special dough and dough container such that where the dough has been specially designed to allow the baking of ingredients to remain moist on the inside while forming a crust on the outside. A small vent is formed on the dough. The item is then baked in an oven and can be either served immediately afterwards, or can be frozen for later heating and consumption.

### REFERENCE TO RELATED APPLICATIONS

This application claims an invention which was disclosed in Provisional Application No. 60/846,276, filed Sep. 26, 2006, entitled “BURGER BUNDLE”. The benefit under 35 USC §119(e) of the United States provisional application is hereby claimed, and the aforementioned application is hereby incorporated herein by reference.

### FIELD OF THE INVENTION

The present invention relates generally to food processing, more specifically relating to a method and apparatus for precooked and portable sandwiches.

### BACKGROUND

Process for making covered pizza is known. U.S. Pat. No. 3,615,678 to Tangel, et al. discloses a process for producing pizza having two dough layers with a tomato base sauce in a pocket between them; the dough is made of durum flour and leavening, is formed into sheets, a quantity of sauce is placed between the sheets, the raw pizza being then proofed, and cooked between plates having a predetermined spacing.

Method of making a pizza is known. U.S. Pat. No. 4,661,361 to Mongiello, et al. discloses a pizza shell and a method for forming pizza shells. The pizza shell comprises a dough base, a plurality of closed pockets uniformly distributed about at least a portion of the base, and a plurality of food portions held within those closed pockets. To form the pizza shell, a flat dough base is formed, a plurality of food portions are placed on the dough base, the food portions are covered, and a plurality of closed pockets are formed to enclose each food portion within a separate closed pocket. The pizza shell is then used in a conventional manner to make a pizza pie.

Method for preparing a baked dough food product is known. U.S. Pat. No. 5,756,137 to Viviano, et al. discloses a method for forming a dough food product wherein a layer of dough is disposed upon a surface. A filling ingredient is disposed upon a first region of the layer of dough. A second region of the layer of dough is folded over the first region to cover the filling ingredient and form a pocket enclosing the filling ingredient. The pocket has an external folded edge formed by the folded layer of dough and a plurality of unsealed external edges. Seals are formed around the filling ingredient by sealingly joining the first and second regions along the external unsealed edges. The maximum fat content of the filling ingredient is selected in order to substantially eliminate breaking of the seals. The pocket can include a plurality of filling ingredient servings that can be individually sealed to form a plurality of subpockets.

Separately cooking a first outside part and a second outside part of a food product is known. U.S. Pat. No. 5,780,082 to Rebeaud discloses a process for the manufacture of a food product of the pizza type, which is in the shape of a pocket and edible as a sandwich. The process consists of: cooking a bottom raised pizza crust with its ingredients, of roughly rectangular shape, in a pizza oven, on the hearth and at the ambient heat of this oven, in the classical manner, up to a point near complete cooking; covering the bottom crust with its ingredients thus cooked with a thin raised pizza crust forming an envelope and enclosing the ingredients in a hermetic manner on the bottom crust, and making it one piece with the bottom crust by its edges; and placing the assembly obtained in the manner in the oven once again so as to cook the enveloped crust.

Microwave heatable bread-based fast food is known. U.S. Pat. No. 6,881,431 to Kawase, et al. discloses a fast food product, such as hot dogs or hamburgers, buns or rolls which are adapted for heating together with a cooked meat product inserted therein produced from a dough containing hard white wheat flour as at least part of the starting wheat flour, rice koji and vitamin C. The dough contains a effective amount of yeast and appropriate amounts of conventional additives such as sodium chloride, sugar, oil and fats, milk powder and the like. The dough is free from yeast food, potassium bromate and an emulsifier. The fast food products are packaged with a microwave heatable packaging material in a cooled or refrigerated or frozen state for storage or shipping.

Bread-based fast food such as hot dogs or hamburgers remains tasteful while the bread is as hot as baked and the sausages or hamburger steaks are kept warm. Once cooled, their unique taste and flavor is significantly lost. Microwave heating of cold fast food of this kind cannot resume their original taste and flavor because their bread parts are heated for an excessive period of time before the inserted meat products reach an optimum temperature suitable for eating. Furthermore, excessive heating of the bread tends to shrink and create wrinkles on surfaces thereby causing partial destruction of the bread texture. Therefore, it is desirous to have a pizza-based product allowing food that has been precooked to be reheated and still remain tasteful and moist.

### SUMMARY OF THE INVENTION

A method for making a food product such that the food product is tasteful to the palate is provided.

A method for making a food product such that the food product pre-cooked and adapted to be re-heated is provided.

A food product having a dough such that the finished food product possess the quality of allowing the ingredients therein to remain moist, and forming a crust on the outside while remaining moist inside is provided.

A finished food product suitable for frozen and later re-heated while maintaining a desired taste is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a burger bundle in accordance with some embodiments of the invention.

FIG. 2 is an example of a heating process in accordance with some embodiments of the invention.

FIG. 3 is an exemplified process in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to {replace with a technical description of the invention in a few words}. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

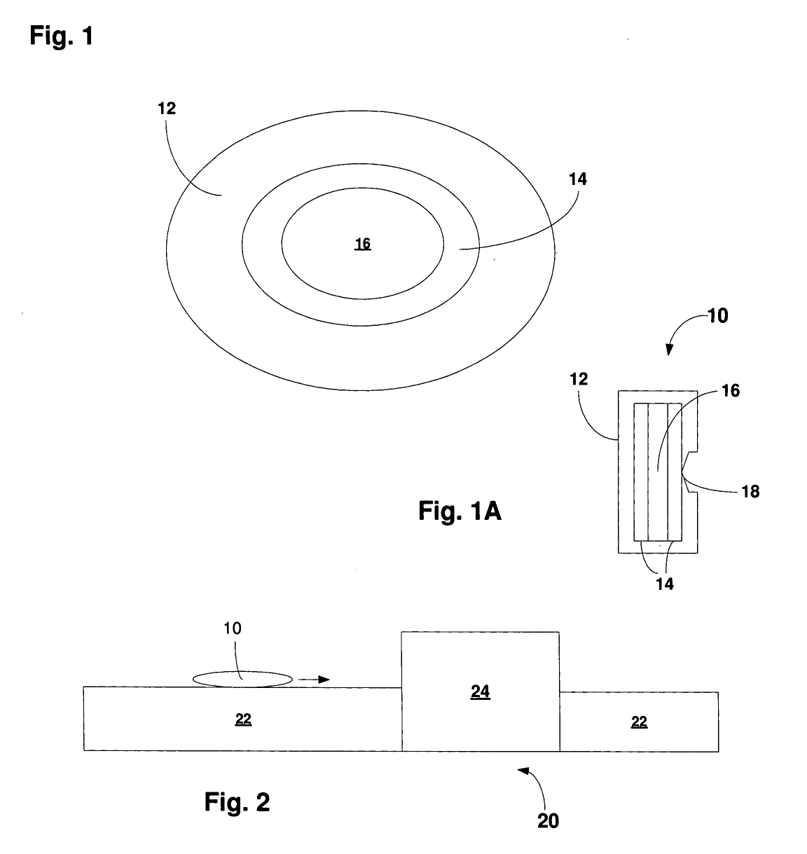

Referring to FIGS. 1-3, a preferred embodiment of the present invention is shown. In FIG. 1, a part of a food product 10 such as a hamburger having a dough layer 12 forming the outside portion thereof is provided food product 10 further has a first layer of filling 14 and a second layer of filling 16 with first layer filling 14 interposed between dough layer 12 and second layer filling 16. First layer filling 14 is typically a colder filling such as cheese or vegetable add-ons. Whereas second layer filling 16 is typically a hotter filling such as precooked ground meat or the like such as a vegeburger.

Dough layer 12 may be formed in a known manner by cutting from a elongated dough member (not shown). First layer filling 14 and second layer filling 16 may be deposited on the dough member sequentially with first layer filling 14 deposited first and second layer filling 16 afterwards.

FIG. 1A is a sectional view of food product 10. Dough layer 12 is formed such that first layer filling 14 and second layer filling 16 are completely enveloped therein except a slit 18 formed or cut on one of the flat sides. As can be seen, first layer filling 14 and dough layer 12 are formed such that they are substantially in surface contact. Whereas, second layer filling 16 is in substantial contact with first layer filling 14 but not significantly in contact with dough layer 12. This way, freshness of food product 10 can be advantageously achieved. Furthermore, second layer filling 16 is typically precooked.

In FIG. 2, a cooking system 20 for food product 10 is depicted. food product 10 passed from a conveyor belt 22 into an oven 24 and stays therein for a suitably sufficient period of time and packaged thereafter.

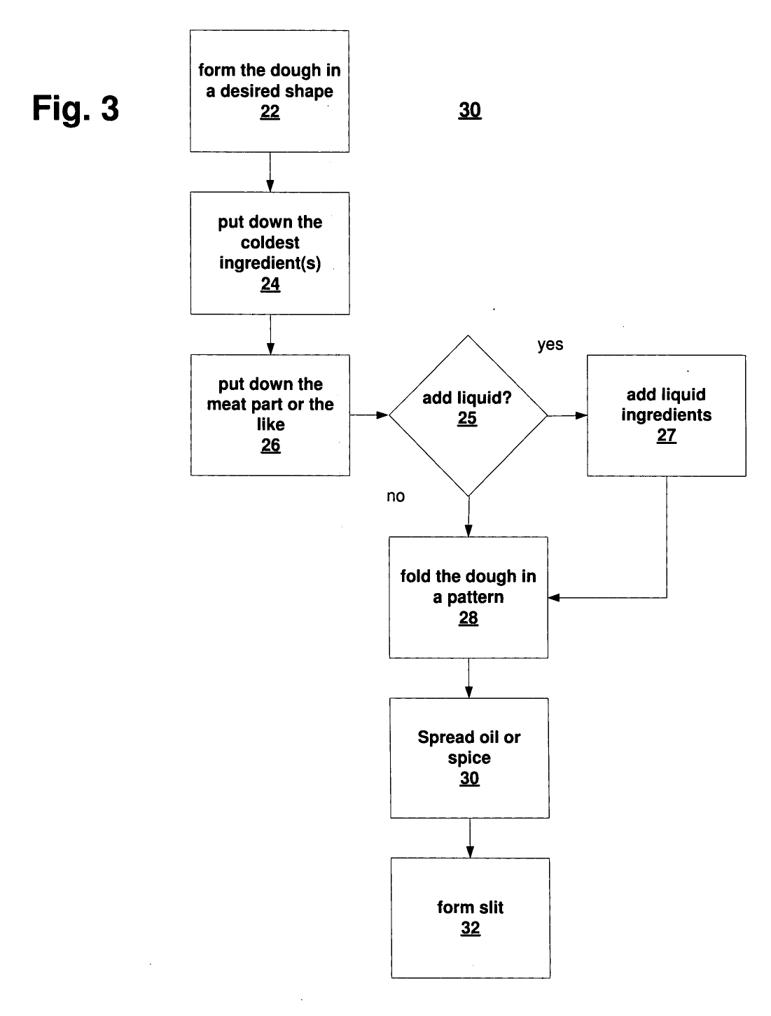

In FIG. 3, a process 30 for making or producing food product 10 is shown. Dough layer 12 is formed (Step 22). Dough layer 12 is a specially formulated dough, which allows baking of the ingredients such as dough layer 12 to remain moist on the inside while forming a crust on the outside. This allows for a variety of first layer filling 14 and second layer filling 16 and the like to be used free from worrying about over or under cooking. Dough layer 12 is formed into a circle with the circumference ranging from a diameter of six to ten inches (6″-10″).

The order of layering the ingredients is critical to the baking process 20. Put on the first layer 14 such that the coldest ingredients are put down first on dough layer 12, and then followed by the pre-cooked hamburger and then the liquid ingredients (Step 24). Put down second layer filling 16 after the first layer 14 is put upon the dough layer 12 (Step 26). The ingredients or layers are put on in this order so as to prevent over or under cooking of the ingredients and dough. Lastly, the liquid ingredient(s) such as sauce, etc may be added (Step 27). A determination is made as to whether liquid ingredients are required (Step 25). If true, liquid such as sauce, etc. are added (Step 27). Once the ingredients comprising first layer filling 14 and second layer filling 16 are in place, the next step is to specifically fold the dough 12 in a pattern by creating a blanket without seems and making sure the blanket is uniform in that it is not top thick in any single area (Step 28). Spread a small amount of a combination of margarine and a specially blend of seasonings on the top (Step 30). Create at least one vent slit 18 on food product 10 (Step 32). The venting slits need to be placed in certain areas to allow venting of the steam build up therein without too much internal heat loss. This combination of steps allows the food product 10 to be frozen and reheated by various means without any loss of flavor or composition. Further, the oven temperature and belt speed need to set to allow the food product 10 to be properly cooked based on the special formulae or examples listed infra. The following lists various examples of the present inventions.

I. Pizza Burger Bundle
1. Start with dough layer 12 which comprises of four-to-seven (4-7) ounces of a specially formulated dough in the form of a round circle like or annular shape having twice the size or area of the hamburger second layer filling 16 being used.
2. Put two (2) ounces of cheeses first layer filling 14 on the dough, which consists of pasteurized milk, part skim milk cheese culture, salt and enzymes, cellulose added to prevent caking.
3. Place a 2, 3, 4 or 5 ounce precooked well-done hamburger 16 on the dough.
4. Add two (2) ounces of pizza sauce, twelve (12) pieces of pepperoni.
5. Onions, peppers, bacon, mushrooms and sausage are optional ingredients.
6. Fold up the outside edges so as to completely cover the ingredients and knead the dough together.
7. Rotate the assembled bundle over and make a ¼ inch slit vent 18 with a knife and drizzle with 3 oz butter and sprinkle with special blend of seasonings on top.
8. Bake in a 500° oven for 5 minutes and 42 seconds.
9. Remove from oven and either serve, or cool and wrap, or freeze and wrap depending on where the finished product is to be sold.

II. Chicken Bundle
1. Start with four to seven (4 to 7) ounces of specially formulated dough and form a round circle six to eight (6 to 8) inches in size.
2. Add any combination(s) of the following ingredients first layer filling 14: cheese, onions, peppers, lettuce, tomatoes such that the first layer filling 14 is formed substantially in contact with dough layer 12.
3. Place four to seven (4 to 7) ounces of precooked breaded chicken on dough having first layer filling 14 interposed therebetween.
4. Add any combination(s) of the following ingredients: ranch dressing, barbeque sauce, bacon or hot sauce.
5. Fold up the outside edges so as to completely cover the ingredients and knead the dough together.
6. Rotate the assembled bundle food product 10 over and make a small ¼ inch vent slit with a knife and drizzle with 3 oz butter and sprinkle said special blend of said seasonings on top.
7. Bake in 500° oven for 5 minutes and 42 seconds.
8. Remove from oven and either serve, or cool and wrap, or freeze and wrap depending on where the finished product is to be sold.

III. Diced Chicken Bundle
1. Start with four to seven (4 to 7) ounces of specially formulated dough and form a round circle six to eight (6 to 8) inches in size.
2. Add any combination(s) of the following ingredients: cheese, onions, peppers, lettuce, tomatoes.
3. Place four to seven (4 to 7) ounces of precooked diced chicken on dough
4. Add any combination(s) of the following ingredients: ranch dressing, barbeque sauce, bacon or hot sauce.
5. Fold up the outside edges of dough layer 12 so as to completely cover the ingredients and knead the dough together.
6. Rotate the assembled bundle over and make a small ¼ inch vent slit with a knife and drizzle with 3 oz butter and sprinkle said special blend of said seasonings on top.
7. Bake in 500° oven for 5 minutes and 42 seconds.
8. Remove from oven and either serve or cool and wrap or freeze and wrap depending on where product is to be sold.

IV. Burger Bundle
1. Start with four to seven (4 to 7) ounces of specially formulated said dough and form a round circle twice the size of the hamburger being used.
2. Add any combination(s) of the following ingredients: cheese, onions, peppers, lettuce, tomatoes.
3. Place a 2, 3, 4, or 5 ounce precooked well-done hamburger on the dough.
4. Add any combination(s) of the following ingredients: ranch dressing, barbeque sauce, bacon, mushrooms, ketchup, mustard, pickles, relish or hot sauce.
5. Fold up the outside edges so as to completely cover the ingredients and knead the dough together.
6. Rotate the assembled bundle over and make a small ¼ inch vent slit with a knife and drizzle with 3 oz of butter and sprinkle special blend of said seasonings on top.
7. Bake in 500° oven for 5 minutes and 42 seconds.
8. Remove from oven and either serve or cool and wrap or freeze and wrap depending on where product is to be sold.

V. Double Burger Bundle
1. Start with four to seven (4 to 7) ounces of specially formulated said dough and form a round circle twice the size of the hamburger being used
2. Add any combination(s) of the following ingredients: cheese, onions, peppers, lettuce, and tomatoes.
3. Place 2 3 or 4 ounce precooked well-done hamburgers on the dough.
4. Add any combination(s) of the following ingredients: ranch dressing, barbeque sauce, bacon, mushrooms, ketchup, mustard, pickles, relish or hot sauce.
5. Fold up the outside edges so as to completely cover the ingredients and knead the dough together.
6. Rotate the assembled bundle over and make a small ¼ inch vent slit with a knife and drizzle with 3 oz of butter and sprinkle special blend of said seasonings on top.
7. Bake in 500° oven for five (5) minutes and forty-two (42) seconds.
8. Remove from oven and either serve, or cool and wrap, or freeze and wrap depending on where product is to be sold.
VI. Vegetable Bundle
1. Start with four to seven (4 to 7) ounces of specially formulated dough and form a round circle twice the size of the veggie burger.
2. Add any combination(s) of the following ingredients: lettuce, tomato, onions.
3. Place a 2, 3, 4, or 5 ounce precooked well-done veggie patty on the dough.
4. Add any combination(s) of the following ingredients: ketchup mustard, mayo, cheese, pickles or relish.
5. Fold up the outside edges so as to completely cover the ingredients and knead the dough together.
6. Rotate the assembled bundle over and make a small ¼ inch vent slit with a knife and drizzle with 3 oz of butter and sprinkle special blend of said seasonings on top.
7. Bake in 500° oven for five (5) minutes and forty-two (42) seconds.
8. Remove from oven and either serve, or cool and wrap, or freeze and wrap depending on where product is to be sold.

VII. Barbeque Bundle
1. Start with four to seven (4 to 7) ounces of specially formulated said dough and form a round circle 6 to 8 inches in size.
2. Add any combination of the following ingredients: lettuce, tomato, cheese, bacon, mushrooms.
3. Place 4 ounces of precooked barbequed pulled pork on the dough.
4. Add any combination of the following ingredients: mayo, barbeque sauce or hot sauce.
5. Fold up the outside edges so as to completely cover the ingredients and knead the dough together.
6. Rotate the assembled bundle over and make a small ¼ inch vent slit with a knife and drizzle with 3 oz of butter and sprinkle special blend of said seasonings on top.
7. Bake in 500° oven for five (5) minutes and forty-two (42) seconds.
8. Remove from oven and either serve, or cool and wrap, or freeze and wrap depending on where product is to be sold.

The food product of the present invention is tasteful as well as being able to be reheated while still maintain the tastefulness. The dough 12 is a specially formulated dough that consists of: Enriched Flour (Niacin, Reduced Iron, Thiamine Mononitrate, Riboflavin, Folic Acid, Malted Barley Flour) Water, Sugar, Salt, Yeast, Liquid Soybean, Oil, Margarine (Partially Hydrogenated Soybean Cottonseed and/or Canola Oil, Lecithin, Mono And Diglycerides, Potassium Sorbate, Citric Acid, Artificially Flavored Vitamin A. Palmitate, Carotene), Malt, and weighs between four to seven (4 to 7) ounces. dough layer 12 is formed into a circle twice the size of the second layer filling 16 such as a hamburger being used. The hamburger that is used is a precooked, well-done, and weighing between two to five (2 to 5) ounces. The chicken that is used weighs between four to seven (4 to 7) ounces and is precooked breaded chicken or precooked diced chicken both of which being well done. The veggie burger that is used is a precooked well-done patty weighing between two to five (2 to 5) ounces. The ingredients are placed on the dough and then the dough is folded up completely, thereby enclosing all of the ingredients to form a bundle of about four to six (4-6) inches in diameter and between two to four (2-4) inches high. The final steps before cooking are to make a small ¼ inch vent slit with a knife in the top to allow venting while cooking and to drizzle 3 oz of butter on the top and sprinkle a special blend of seasonings on it made from pasteurized cow's milk, culture, salt, and enzymes, Corn Starch and cellulose are added to prevent caking. Garlic and oregano are added for flavor. The Burger Bundle 10 is then baked in a 500° oven for five (5) minutes and forty-two (42) seconds. When done, food product 10 may be either served, or cooled then packaged for distribution, or quick frozen and packaged for distribution.

Various known automation method and apparatus may be used for producing the food product or implementing the method for making same.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for producing a food product comprising the steps of:
a. forming a dough layer;
b. forming a first filling layer substantially in contact with the dough layer; and
c. placing a second filling layer on the first filling layer.

2. The method of claim 1 further comprising the steps of folding the dough layer, and sealing the dough layer.

3. The method of claim 1 further comprising the step of forming at least one vent slit on the food product.

4. The method of claim 1 further comprising the step of spread a small amount of a combination of margarine and a specially blend of seasonings on top of the food product.

5. The method of claim 1 further comprising the step of heating the food product.

6. The method of claim 1, wherein the first filling layer comprises the coldest ingredient or filling.

7. The method of claim 1, wherein the second filling layer comprises pre-cooked meat or a pre-cooked imitation thereof.

8. A food product produced according to a method comprising the steps of:
a. forming a dough layer;
b. forming a first filling layer substantially in contact with the dough layer; and
c. placing a second filling layer on the first filling layer.

9. The food product of claim 8, wherein the method further comprising the steps of folding the dough layer, and sealing the dough layer.

10. The food product of claim 8, wherein the method further comprising the step of forming at least one vent slit on the food product.

11. The food product of claim 8, wherein the method further comprising the step of spread a small amount of a combination of margarine and a specially blend of seasonings on top of the food product.

12. The food product of claim 8, wherein the method further comprising the step of heating the food product.

13. The food product of claim 8, wherein the first filling layer comprises the coldest ingredient or filling.

14. The food product of claim 8, wherein the second filling layer comprises pre-cooked meat or a pre-cooked imitation thereof.
